(19) United States
(12) Patent Application Publication
(10) Pub. No.: US 2020/0150855 A1
(43) Pub. Date: May 14, 2020

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventors: Wataru UNO, Kanagawa (JP); Ryota OZAKI, Kanagawa (JP); Noriji KATO, Kanagawa (JP)

(73) Assignee: FUJI XEROX CO., LTD., Tokyo (JP)

(21) Appl. No.: 16/373,648

(22) Filed: Apr. 3, 2019

(30) Foreign Application Priority Data
Nov. 8, 2018 (JP) 2018-210594

(51) Int. Cl. G06F 3/0484; G06F 3/0483; G06F 3/0485; G06F 16/955; G06F 16/9538; G06N 20/00

(52) U.S. Cl. CPC G06F 3/04845; G06F 3/0483; G06N 20/00; G06F 16/955; G06F 16/9538; G06F 3/0485

(57) ABSTRACT

An information processing apparatus includes an acquisition unit that acquires, from plural pieces of first information viewed by a user, content information being information of contents described in the first information, an extraction unit that extracts a location in which the user has performed editing, from second information as a target of the user working, and a specifying unit that specifies the first information viewed during a period in which the user performs editing at the location or viewed before and after the editing among the plural pieces of first information from the content information.

### CROSS-REFERENCE TO RELATED APPLICATIONS

This application is based on and claims priority under 35 USC 119 from Japanese Patent Application No. 2018-210594 filed Nov. 8, 2018.

### BACKGROUND

### (i) Technical Field

The present invention relates to an information processing apparatus and a non-transitory computer readable medium storing a program.

### (ii) Related Art

For example, JP5185240B discloses a server apparatus capable of improving the degree of interest of a user in a Web page. The server apparatus includes information acquisition means for acquiring scroll operation information for a display area of a terminal device and content specifying information for specifying contents displayed in the display area from a terminal device and interest-degree calculation means for calculating the degree of interest of a user in contents specified by the acquired content specifying information, based on the acquired scroll operation information. The interest-degree calculation means adjusts the degree of interest by weighting depending on a parameter influenced by time taken for the user to grasp details of the contents, in a case where the interest-degree calculation means calculates the degree of interest based on the scroll operation information.

### SUMMARY

In a case where information is edited by referring to descriptions of a plurality of Web pages, there may be a useful Web page and a useless Web page for editing.

Aspects of non-limiting embodiments of the present disclosure relate to an information processing apparatus and a non-transitory computer readable medium storing a program in which first information used in a case where editing is performed at a location in second information can be specified in a case where the second information is edited using the descriptions of the first information.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus which includes an acquisition unit that acquires, from a plurality of pieces of first information viewed by a user, content information being information of contents described in first information, an extraction unit that extracts a location in which the user has performed editing, from second information as a target of the user working, and a specifying unit that specifies the first information viewed during a period in which the user performs editing at the location or viewed before and after the editing among the plurality of pieces of first information from the content information.

### BRIEF DESCRIPTION OF THE DRAWINGS

Exemplary embodiment(s) of the present invention will be described in detail based on the following figures, wherein:

FIG. 1 is a diagram illustrating an example of a configuration of a network system according to an exemplary embodiment;

FIG. 2 is a block diagram illustrating an example of an electrical configuration of a server apparatus according to the exemplary embodiment;

FIG. 3 is a block diagram illustrating an example of a functional configuration of the server apparatus according to the exemplary embodiment;

FIG. 4 is a diagram illustrating an example of a viewing history in the exemplary embodiment;

FIG. 5 is a diagram illustrating an example of content information in the exemplary embodiment;

FIG. 6 is a diagram illustrating an example of interaction information in the exemplary embodiment;

FIG. 7 is a diagram illustrating an example of work information in the exemplary embodiment;

FIG. 8 is a diagram illustrating an example of features in the exemplary embodiment;

FIG. 9 is a flowchart illustrating an example of a flow of feature creation processing by a learning processing program in the exemplary embodiment;

FIG. 10 is a flowchart illustrating an example of a flow of learning processing by the learning processing program in the exemplary embodiment; and

FIG. 11 is a flowchart illustrating an example of a flow of processing by a specifying processing program in the exemplary embodiment.

### DETAILED DESCRIPTION

Hereinafter, an exemplary embodiment for embodying the present invention will be described in detail with reference to the drawings.

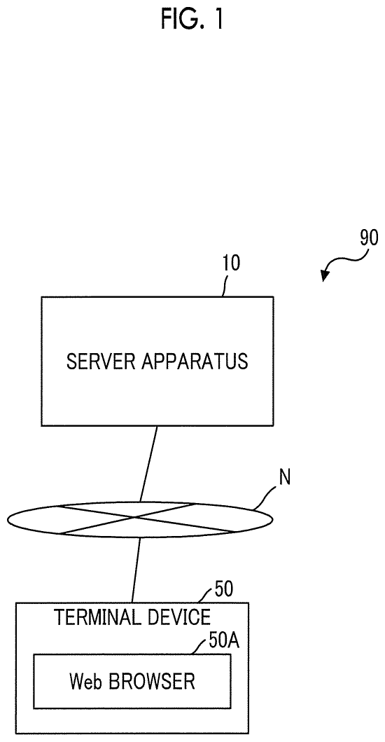

FIG. 1 is a diagram illustrating an example of a configuration of a network system 90 according to an exemplary embodiment.

As illustrated in FIG. 1, the network system 90 according to the exemplary embodiment includes a server apparatus 10 and a terminal device 50. The server apparatus 10 is an example of an information processing apparatus. As an example, a server computer or a general-purpose computer device such as a personal computer (PC) is applied as the server apparatus 10.

The server apparatus 10 according to the exemplary embodiment is connected to the terminal device 50 via a network N. As an example, the Internet, a local area network (LAN), or a wide area network (WAN) is applied as the network N. As an example, a general-purpose computer device such as a personal computer (PC) or a portable computer device such as a smartphone and a tablet terminal is applied as the terminal device 50 according to the exemplary embodiment.

A Web browser 50A is installed on the terminal device 50 in the exemplary embodiment. The Web browser 50A is software for accessing a Web site via the network N and viewing a Web page provided in the accessed Web site.

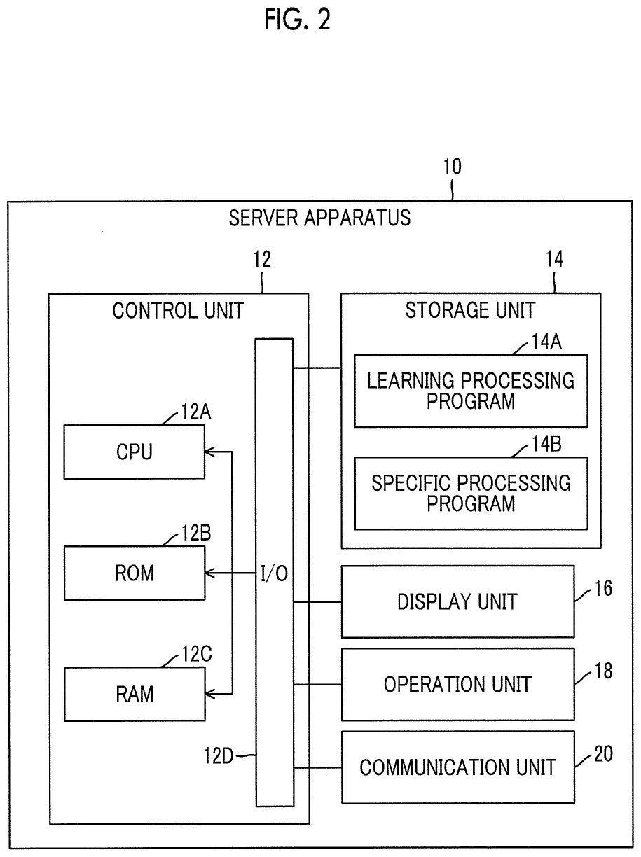

FIG. 2 is a block diagram illustrating an example of an electrical configuration of the server apparatus 10 in the exemplary embodiment.

As illustrated in FIG. 2, the server apparatus 10 in the exemplary embodiment includes a control unit 12, a storage unit 14, a display unit 16, an operation unit 18, and a communication unit 20.

The control unit 12 includes a central processing unit (CPU) 12A, a read only memory (ROM) 12B, a random access memory (RAM) 12C, and an input and output interface (I/O) 12D. The units are connected to each other via a bus.

The functional units including the storage unit 14, the display unit 16, the operation unit 18, and the communication unit 20 are connected to the I/O 12D. Each of the functional units is capable of communicating with the CPU 12A via the I/O 12D.

The control unit 12 may be configured as a sub-control unit that controls some operations of the server apparatus 10 or may be configured as a portion of the main control unit that controls all operations of the server apparatus 10. For example, an integrated circuit such as large scale integration (LSI) or an integrated circuit (IC) chip set is used in a portion or the entirety of each block in the control unit 12. An individual circuit may be used for each block, or a circuit in which some or all of blocks are integrated may be used. The blocks may be provided as a single unit, or some blocks may be separately provided. A portion of each of the blocks may be separately provided. Integration of the control unit 12 is not limited to LSI, and a dedicated circuit or a general-purpose processor may be used as the control unit 12.

For example, a hard disk drive (HDD), a solid state drive (SSD), or a flash memory is used as the storage unit 14. A learning processing program 14A for realizing learning processing according to the exemplary embodiment and a specifying processing program 14B for realizing first information specifying processing according to the exemplary embodiment are stored in the storage unit 14. The learning processing program 14A and the specifying processing program 14B may be stored in the ROM 12B.

The learning processing program 14A and the specifying processing program 14B may be installed on the server apparatus 10 in advance, for example. The learning processing program 14A and the specifying processing program 14B may be realized by being stored in a non-volatile storage medium or by being distributed via the network N and being appropriately installed on the server apparatus 10. As an example of the non-volatile storage medium, a compact disc read only memory (CD-ROM), a magneto-optical disk, an HDD, a digital versatile disc read only memory (DVD-ROM), a flash memory, and a memory card are assumed.

For example, a liquid crystal display (LCD) or an organic electroluminescence (EL) device is used as the display unit 16. The display unit 16 may integrally include a touch panel. For example, a device for inputting an operation, such as a keyboard and a mouse, is provided as the operation unit 18. The display unit 16 and the operation unit 18 receive various instructions from a user of the server apparatus 10. The display unit 16 displays various kinds of information, for example, a result of processing performed in accordance with an instruction received from the user and a notification for processing.

The communication unit 20 is connected to the network N such as the Internet, a LAN, or a WAN, and thus communication between the communication unit 20 and the terminal device 50 is allowed via the network N.

As described above, in a case where a user edits second information (as an example, a document and a source code) on which the user is working, by using descriptions of a plurality of pieces of first information (as an example, Web pages), there may be first information which is useful in editing and first information which is useless. In this case, in a case where a point that the first information is used for editing second information may be specified, this may act as a criterion of a determination that the information is useful in editing. However, the operation of specifying the point that the first information is used for editing the second information has not been performed.

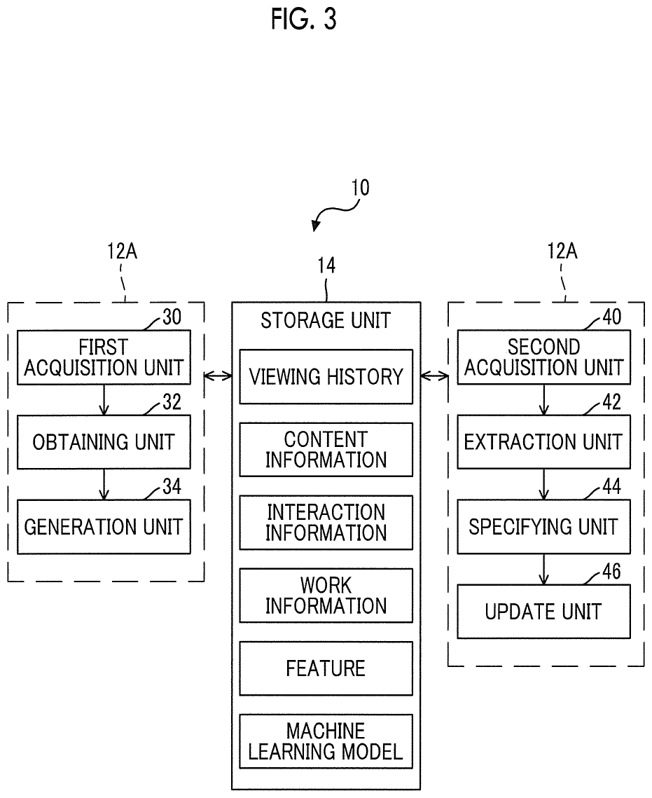

Therefore, the CPU 12A of the server apparatus 10 in the exemplary embodiment functions as the units illustrated in FIG. 3 by writing the learning processing program 14A and the specifying processing program 14B stored in the storage unit 14, in the RAM 12C and then executing the programs 14A and 14B.

FIG. 3 is a block diagram illustrating an example of a functional configuration of the server apparatus 10 in the exemplary embodiment.

As illustrated in FIG. 3, the CPU 12A of the server apparatus 10 in the exemplary embodiment executes the learning processing program 14A to function as a first acquisition unit 30, an obtaining unit 32, and a generation unit 34. The CPU 12A executes the specifying processing program 14B to function as a second acquisition unit 40, an extraction unit 42, a specifying unit 44, and an update unit 46. In the exemplary embodiment, the first acquisition unit 30 and the second acquisition unit 40 will be separately described. However, the first acquisition unit 30 and the second acquisition unit 40 may be integrally realized as one acquisition unit.

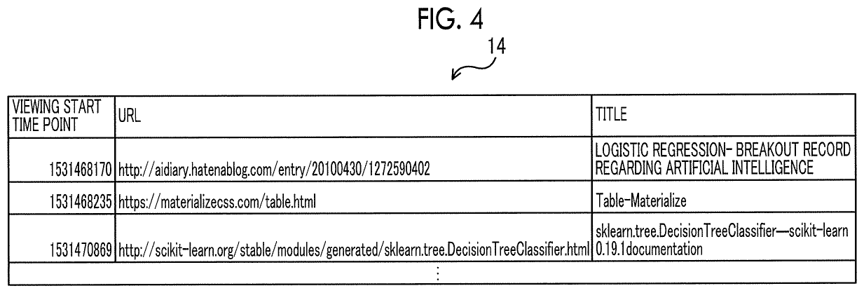

Firstly, learning processing according to the exemplary embodiment will be described with reference to FIGS. 4 to 8.

FIG. 4 is a diagram illustrating an example of a viewing history in the exemplary embodiment.

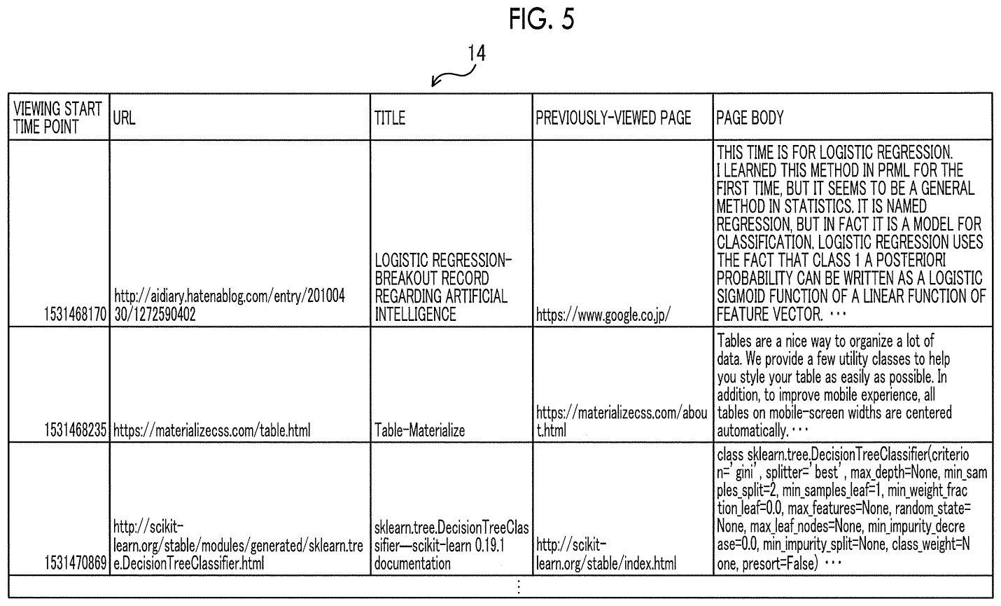

FIG. 5 is a diagram illustrating an example of content information in the exemplary embodiment.

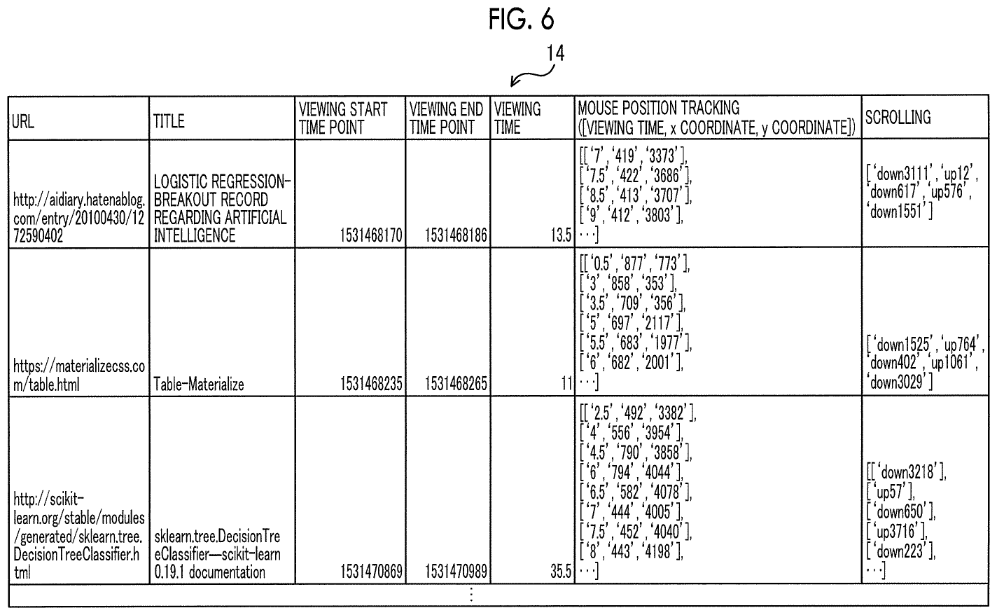

FIG. 6 is a diagram illustrating an example of interaction information in the exemplary embodiment.

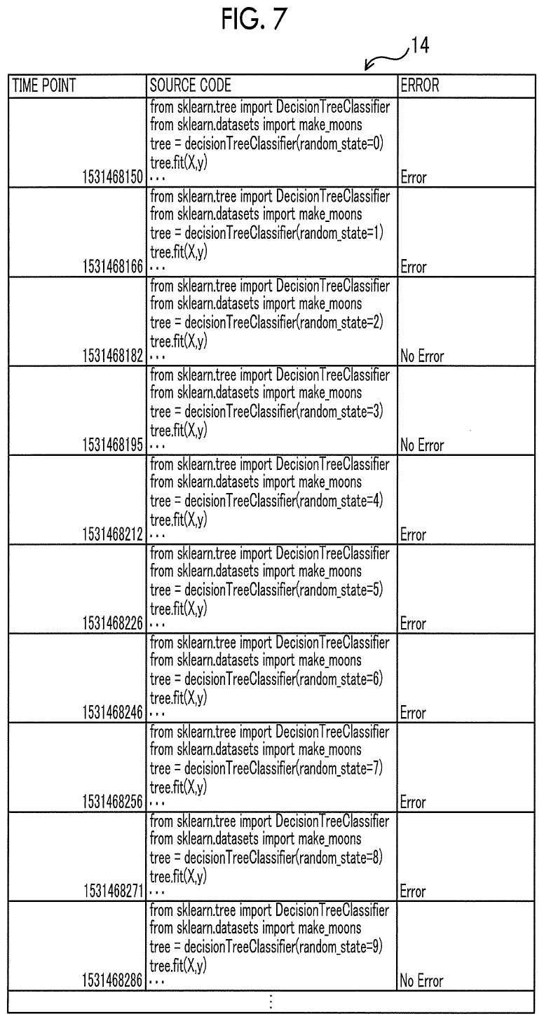

FIG. 7 is a diagram illustrating an example of work information in the exemplary embodiment.

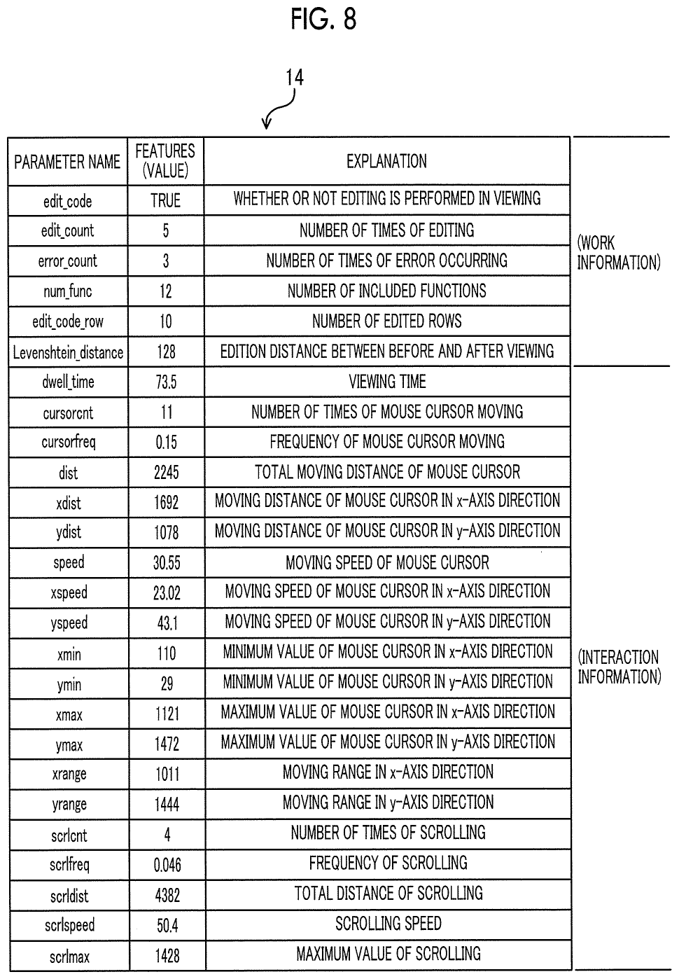

FIG. 8 is a diagram illustrating an example of features in the exemplary embodiment.

In the exemplary embodiment, the first acquisition unit 30 acquires a viewing history of a Web page viewed by a user of the terminal device 50 with the Web browser 50A, and stores the acquired viewing history in the storage unit 14. As an example, as illustrated in FIG. 4, the viewing history includes information of a uniform resource locator (URL), a title, a viewing start time point, and the like. The Web page is an example of the first information. Here, the first information may be information of which a log can be acquired and is not limited to the Web page.

The first acquisition unit 30 acquires content information from the Web page acquired as the viewing history. The content information is information of contents described in the Web page. As an example, as illustrated in FIG. 5, the content information includes information of a viewing start time point, a URL, a title, a URL of a previously-viewed page, a page body, and the like. The content information may include information of DOCTYPE (version of html), a window size, a document size, and the like.

The first acquisition unit 30 acquires interaction information for each Web page acquired as the viewing history. The interaction information is information regarding an operation performed on the Web page by the user. The interaction information includes information obtained from details of an operation performed on the Web page with an input device used by the user. As an example, a keyboard or a mouse is used as the input device here. As an example, as illustrated in FIG. 6, the interaction information includes information of a URL, a title, a viewing start time point, a viewing end time point, a viewing time, position tracking of a mouse as an example of the input device, scrolling, and the like. More specifically, the interaction information includes information of a viewing start time point and a viewing end time point of a Web page, whether or not a mouse is on a window, a viewing position for each predetermined time, a moving position of the mouse, a scrolling distance, a transition of a tab, the number of copying operations, the number of drag operations, the number of times of clicking a link, and the like. For example, the unit that acquires the interaction information may be realized as the extension function of the Web browser 50A or may be realized by using Javascript (registered trademark) embedded in the Web page.

The first acquisition unit 30 acquires work information regarding a work performed on target work data as a target of the user working on. In the exemplary embodiment, it is assumed that the user performs a work on target work data with the terminal device 50. Examples of the target work data include a document and a source code. For example, in a case where the user performs programming, as an example, as illustrated in FIG. 7, the work information includes information of a history of editing a source code as an example of the target work data, a time stamp, whether or not an error occurs, and the like. For example, in a case where the user creates any document, the work information includes a history of editing the document as an example of the target work data and a time stamp. As an example, editing of a document includes creating and editing of a document with document creation software, creating and editing of presentation slides with presentation software, and creating and editing of an electronic mail with electronic mail software. The target work data is an example of the second information.

The viewing history, the content information, the interaction information, and the work information obtained in the above-described manner are stored in the storage unit 14.

The obtaining unit 32 according to the exemplary embodiment obtains features for being input to a machine learning model described later by receiving the content information, the interaction information, and the work information described above, as an input. Here, for example, the obtaining unit 32 compares a viewing start time point in the content information, the viewing start time point in the interaction information, and the time stamp in the work information, which are obtained from the Web page. The obtaining unit 32 associates the work information in the vicinity of a viewing time point of the Web page with the Web page. Thus, the content information, the interaction information, and the work information are associated with the Web page.

As an example, as illustrated in FIG. 8, the features obtained from the work information include whether or not a document in being viewed is edited, the number of times of editing, the number of times of an error occurring, the number of included functions, the number of edited rows, and an editing distance before and after viewing. As an example, as illustrated in FIG. 8, the features obtained from the interaction information include viewing time, the number of times of a mouse cursor moving, a moving distance of the mouse cursor (including an x-axis direction and a y-axis direction), a moving speed of the mouse cursor, which is obtained by dividing the moving distance of the mouse cursor by the viewing time, . . . , and the maximum value of scrolling. The content information and the work information may be combined with each other. For example, in a case where the work of the user is programming, the number of functions included in the Web page, the function being included in a source code edited at any timing of a timing before the user views the Web page, a timing during viewing of the Web page, or a timing after the user views the Web page, may be used as the features. With the content information and the viewing history, whether or not the Web page as a target of an evaluation has been viewed by a link on the previously-viewed page may be used as the features, or similarity between text of the previously-viewed page and text of the Web page as the target of the evaluation may be used as the features.

The features obtained from the content information, the interaction information, and the work information as described above are stored in the storage unit 14. The features may be obtained from a combination of plural pieces of information or may be obtained from each piece of information.

In the exemplary embodiment, the generation unit 34 generates the machine learning model for determining whether or not a Web page is useful for the user. The machine learning model uses the features obtained by the obtaining unit 32, as an input. As an example, machine learning is performed by using a set of the features and a correct answer label which has been explicitly assigned by the user, as learning data. Examples of an algorithm of the machine learning include the support vector machine, random forests, Gradient Boost, XGboost, and a neural network (including a deep neural network). Regarding an output value of the machine learning model, whether or not usability is provided may be expressed by binary values of 0 (useless) and 1 (useful) or by a probability of 0 to 1. The machine learning model generated in the above-described manner is stored in the storage unit 14.

Next, first information specifying processing according to the exemplary embodiment will be described. In the exemplary embodiment, the first information is a Web page.

In the exemplary embodiment, the second acquisition unit 40 acquires content information described in a Web page, from a plurality of Web pages viewed by the user of the terminal device 50 with the Web browser 50A. The second acquisition unit 40 acquires interaction information regarding an operation performed on the Web page by the user. As an example, the interaction information is information regarding an operation performed on the Web page viewed by the user before or after editing. Time before editing includes a timing just before the editing and a timing within predetermined time (for example, within 30 minutes) before the editing. Time after the editing includes a timing just after the editing and a timing within predetermined time (for example, within 30 minutes) after the editing. The second acquisition unit 40 acquires work information regarding a work performed on target work data at at least one of a timing before the user views the Web page, a timing at which the user views the Web page, or a timing after the user views the Web page. The content information, the interaction information, and the work information are used for specifying a Web page having usability. However, only the content information and the work information except for the interaction information may be included.

In the exemplary embodiment, the extraction unit 42 extracts a location in which the user edits the target work data as a target of the user working on.

In the exemplary embodiment, the specifying unit 44 specifies a Web page viewed during a period in which the user is performing editing at the location or viewed before and after the editing among the plurality of Web pages, from the content information. Specifically, as an example, a viewing start time point of the content information, a viewing start time point of the interaction information, and a time stamp of the work information, which are obtained from the Web page are compared to each other, and the work information in the vicinity of a viewing time point of the Web page is associated with the Web page. Thus, the content information, the interaction information, and the work information are associated with the Web page.

The Web page is specified by determining whether or not at least a portion of the content information is in information described in the location in which the user has edited the target work data. That is, in a case where at least a portion of the content information is in the information described in the location in which editing has been performed, the Web page is specified as a Web page used for editing the target work data. In other words, the Web page is used for improving the quality of a product) as an example, a document or a source code) obtained by a work performed by the user. The Web page may be considered as being useful for the user.

The specifying unit 44 may obtain a value indicating the usability of the specified Web page based on the features obtained from at least one of the content information, the interaction information, or the work information described above, and may specify a Web page having usability based on the obtained value indicating the usability. In this case, the Web page having usability is specified by using a machine learning model in which the features are input, and the value indicating the usability is output. As described above, the machine learning model is a model obtained performing machine learning with learning data in advance. Regarding the value indicating the usability, that is, the output value of the machine learning model, whether or not usability is provided may be expressed by binary values of 0 (useless) and 1 (useful) or by a probability of 0 to 1.

In a case where it is determined, for the user, that an evaluation of usability of the Web page is acquired based on the value which has been obtained by the specifying unit 44 and indicates the usability, the second acquisition unit 40 may acquire the evaluation of the usability of the Web page from the user. Specifically, as an example, in a case where the value indicating the usability is smaller than a threshold and is not sufficiently high, a request for an evaluation is transmitted to the terminal device 50. In a case where the request for an evaluation is transmitted, as an example, a user interface (UI) screen (not illustrated) that allows the user to input the evaluation of the Web page may be displayed on the Web page viewed by the user, so as to urge to the user to input the evaluation. As an example, the evaluation may be a selection formula of “good, bad, and neither” or may be obtained in a plurality of stages (for example, five stages of 1 to 5).

In the exemplary embodiment, the update unit 46 updates the machine learning model by inputting a pair of the evaluation acquired by the second acquisition unit 40 and the features corresponding to the evaluation, as learning data, to the machine learning model. The machine learning model may be updated every time new learning data is added, may be updated in accordance with the number of pieces of data after the predetermined pieces or more of new learning data are gathered, or may be updated regularly.

In a case where the user performs editing two times in the location extracted by the extraction unit 42, the specifying unit 44 may specify the Web page specified in a case of second editing to have usability higher than that of the Web page specified in a case of first editing. In this case, the specifying unit 44 outputs the value indicating the usability of the Web page in which new descriptions are provided in the location to be greater than the value indicating the usability of the Web page which has been firstly specified, and outputs the value indicating the usability of the Web page which has been firstly specified to be smaller than the value indicating the usability of the Web page which has not been specified yet among Web pages viewed by the user. The value indicating the usability here is the output value of the above-described machine learning model.

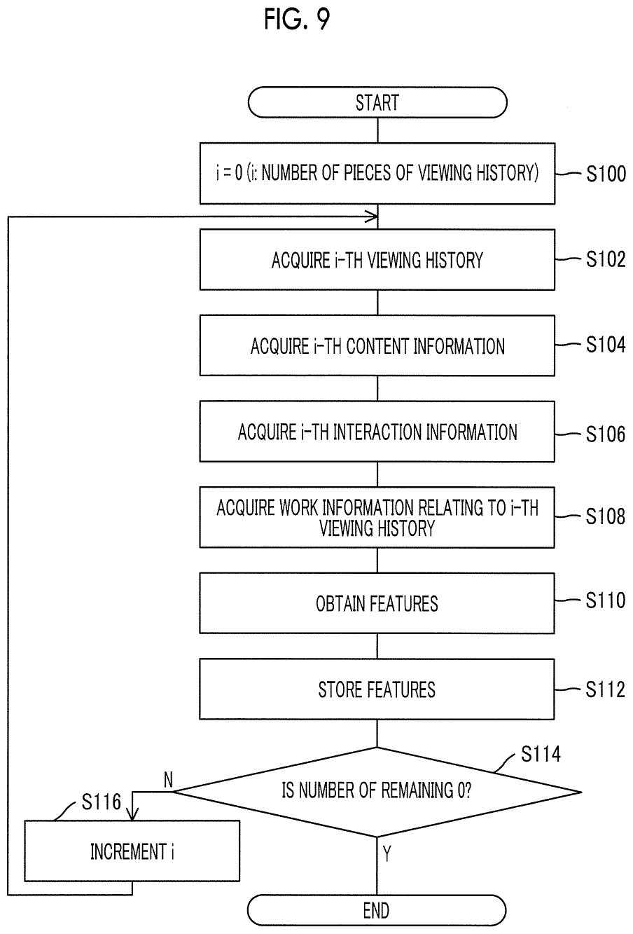

Next, an action of the server apparatus 10 in the exemplary embodiment will be described with reference to FIGS. 9 to 11. In the flowcharts illustrated in FIGS. 9 to 11, descriptions will be made on the assumption that a work of the user editing a source code with reference to the Web page is set as a target.

FIG. 9 is a flowchart illustrating an example of a flow of feature creation processing performed by the learning processing program 14A in the exemplary embodiment.

Firstly, in a case where an instruction to start performing of feature creation processing is transmitted to the server apparatus 10, steps as follows are performed.

In FIG. 9, in Step S100, the first acquisition unit 30 sets i indicating the number of viewing histories of Web pages to 0.

In Step S102, the first acquisition unit 30 acquires the i-th viewing history as illustrated in FIG. 4, as an example. Specifically, the first acquisition unit 30 acquires the viewing history of a Web page viewed by the user of the terminal device 50 with the Web browser 50A.

In Step S104, the first acquisition unit 30 acquires the i-th content information as illustrated in FIG. 5, as an example. Specifically, the first acquisition unit 30 acquires the content information from the Web page acquired as the viewing history in Step S102.

In Step S106, the first acquisition unit 30 acquires the i-th interaction information as illustrated in FIG. 6, as an example. Specifically, the first acquisition unit 30 acquires the interaction information being information regarding an operation performed on the Web page acquired as the viewing history, by the user.

In Step S108, the first acquisition unit 30 acquires work information relating to the i-th viewing history, as illustrated in FIG. 7, as an example. Specifically, the first acquisition unit 30 acquires the work information regarding the work performed on the target work data by the user at any timing of a timing during viewing of the Web page acquired as the viewing history, a timing before the user views the Web page, or a timing after the user views the Web page.

In Step S110, the obtaining unit 32 obtains features as illustrated in FIG. 8, from the content information, the interaction information, and the work information acquired in Steps S104 to S108. Specifically, for example, in a case where the target work data is a source code, the obtaining unit 32 obtains whether or not the source code is edited after the Web page is viewed, the number of times of editing the source code in viewing the Web page, whether or not an error occurs in the source code after the Web page is viewed, the number of functions included in the Web page, in the source code, from the work information and the content information. In addition, as an example, the obtaining unit 32 obtains, from the interaction information, the viewing time of the Web page, the number of times of moving a mouse cursor, the moving distance of the mouse cursor, the moving speed of the mouse cursor, the maximum position and the minimum position of the mouse cursor in the x-axis direction, the maximum position and the minimum position of the mouse cursor in the y-axis direction, the number of times of scrolling, the frequency of scrolling, and the distance of scrolling.

In Step S112, the obtaining unit 32 stores the features obtained in Step S110, in the storage unit 14.

In Step S114, the obtaining unit 32 determines whether or not the number of remaining viewing histories is 0. In a case where it is determined that the number of the remaining viewing histories is not 0 (case of negative determination), the process proceeds to Step S116. In a case where it is determined that the number of the remaining viewing histories is 0 (case of positive determination), the feature creation processing by the learning processing program 14A ends.

In Step S116, the obtaining unit 32 increments indicating the number of viewing histories. The obtaining unit 32 causes the process to return to Step S102 and repeats the steps.

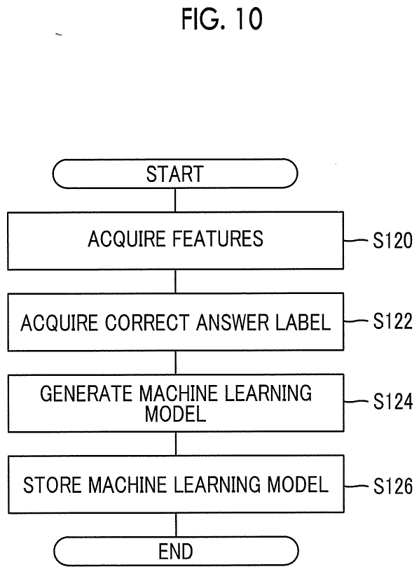

FIG. 10 is a flowchart illustrating an example of a flow of learning processing performed by the learning processing program 14A in the exemplary embodiment.

Firstly, in a case where an instruction to start performing of learning processing is transmitted to the server apparatus 10, steps as follows are performed.

In FIG. 10, in Step S120, the generation unit 34 acquires features stored in the storage unit 14.

In Step S122, the generation unit 34 acquires a correct answer label. Specifically, the generation unit 34 acquires an evaluation (as an example, binary values of 0 and 1) assigned to the Web page acquired as the viewing history by the user, as the correct answer label.

In Step S124, the generation unit 34 generates a machine learning model in which the features with the correct answer label acquired in Step S122 are input, and the value which indicates usability and is obtained by using a machine learning algorithm is output.

In Step S126, the generation unit 34 stores the machine learning model generated in Step S124 in the storage unit 14, and ends the learning processing by the learning processing program 14A.

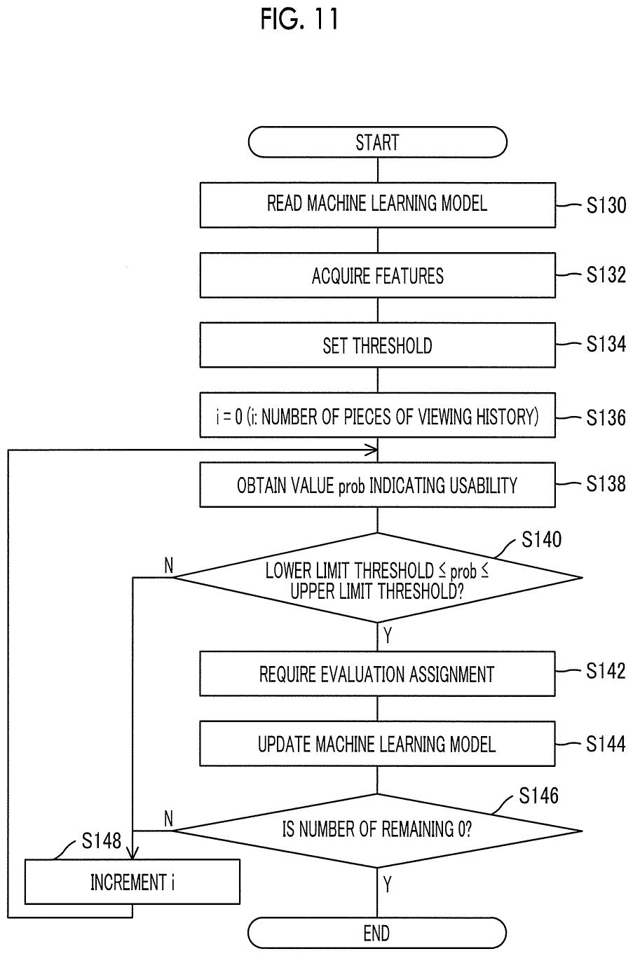

FIG. 11 is a flowchart illustrating an example of a flow of processing performed by the specifying processing program 14B in the exemplary embodiment.

Firstly, in a case where an instruction to start performing of first information specifying processing is transmitted to the server apparatus 10, steps as follows are performed. In the exemplary embodiment, descriptions will be made on the assumption that at least a portion of content information is in information described in a location in which the user has edited target work data.

In FIG. 11, in Step S130, the second acquisition unit 40 reads the machine learning model stored in the storage unit 14.

In Step S132, the second acquisition unit 40 acquires plural kinds of features from each piece of a combination of the content information, the interaction information, and the work information associated with a Web page as an evaluation target.

In Step S134, the specifying unit 44 sets a threshold (upper limit and lower limit) of a value Prob which is output from the machine learning model read in Step S130 and indicates the usability, based on information of the number of pieces of acquired data, data characteristics, and the like.

In Step S136, the specifying unit 44 sets i indicating the number of viewing histories of Web pages as evaluation targets to 0.

In Step S138, the specifying unit 44 inputs the plural kinds of features acquired in Step S132 into the machine learning model read in Step S130 and obtains the value Prob indicating the usability for the Web page associated with the plural kinds of features. In a case where the plural kinds of features are associated with the Web page as an evaluation target, the machine learning model outputs the value Prob indicating one usability for the plural kinds of features. In the exemplary embodiment, the value Prob indicating the usability is set to be expressed by a probability of 0 to 1.

In Step S140, the specifying unit 44 determines whether or not a lower limit threshold ≤Prob≤an upper limit threshold is satisfied. In a case where it is determined that the lower limit threshold ≤Prob≤the upper limit threshold is satisfied (case of positive determination), the process proceeds to Step S142. In a case where it is determined that the lower limit threshold ≤Prob≤the upper limit threshold is not satisfied (case of negative determination), the process proceeds to Step S148.

In Step S142, the second acquisition unit 40 causes a UI screen (not illustrated) for requesting assignment of an evaluation from the user to be displayed in the terminal device 50, and acquires the evaluation of the user for the Web page via the terminal device 50. Specifically, as described above, the user may selectively input the evaluations of “good, bad, and neither” or may input any of a plurality of stages (for example, five stages of 1 to 5) as the evaluation.

In Step S144, the update unit 46 updates the machine learning model by inputting a pair of the user evaluation acquired in Step S142 and features corresponding to the user evaluation, as new learning data, to the machine learning model.

In Step S146, the specifying unit 44 determines whether or not the number of remaining viewing histories is 0. In a case where it is determined that the number of remaining viewing histories is not 0 (case of negative determination), the process proceeds to Step S148. In a case where it is determined that the number of remaining viewing histories is 0 (case of positive determination), the first information specifying processing by the specifying processing program 14B ends.

In Step S148, the specifying unit 44 increments indicating the number of viewing histories. The specifying unit 44 causes the process to return to Step S138 and repeats the steps.

As described above, according to the exemplary embodiment, in a case where the user edits target work data, a Web page used for editing the target work data, that is, a useful Web page for the user is specified from a plurality of Web pages, by using the descriptions of the plurality of Web pages.

Hitherto, the server apparatus is described as an example of the information processing apparatus according to the exemplary embodiment. The exemplary embodiment may have a form of a program for causing a computer to perform the functions of the units in the server apparatus. The exemplary embodiment may have a form of a computer readable storage medium storing the program.

The configuration of the server apparatus described in the exemplary embodiment is just an example and may be changed in accordance with situations in a range without departing from the gist.

The flow of processing in the program described in the exemplary embodiment is also just an example. Thus, an unnecessary step may be removed, a new step may be added, or a processing order may be changed, in the range without departing from the gist.

In the exemplary embodiment, a case where the program is executed, and thereby the processing according to the exemplary embodiment is realized by a software configuration using a computer is described. However, the disclosure is not limited thereto. The exemplary embodiment may be realized by a hardware configuration or a combination of a hardware configuration and a software configuration, for example.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. An information processing apparatus comprising:
an acquisition unit that acquires, from a plurality of pieces of first information viewed by a user, content information being information of contents described in the first information;
an extraction unit that extracts a location in which the user has performed editing, from second information as a target of the user working; and
a specifying unit that specifies the first information viewed during a period in which the user performs editing at the location or viewed before and after the editing among the plurality of pieces of first information from the content information.

2. The information processing apparatus according to claim 1,
wherein the acquisition unit further acquires interaction information being information regarding an operation performed on the first information by the user, and
the specifying unit further specifies the specified first information as first information having usability, by further using the interaction information.

3. The information processing apparatus according to claim 2,
wherein the interaction information is information regarding an operation which has been performed on the first information viewed before or after the editing, by the user.

4. The information processing apparatus according to claim 3,
wherein the interaction information includes information obtained from details of an operation on the first information by an input device used by the user.

5. The information processing apparatus according to claim 4,
wherein the interaction information further includes viewing time being time taken for the user to view the first information.

6. The information processing apparatus according to claim 1,
wherein, in a case where the location extracted by the extraction unit is edited two times by the user, the specifying unit specifies first information specified in second editing to have usability higher than usability of first information specified in first editing.

7. The information processing apparatus according to claim 2,
wherein, in a case where the location extracted by the extraction unit is edited two times by the user, the specifying unit specifies first information specified in second editing to have usability higher than usability of first information specified in first editing.

8. The information processing apparatus according to claim 3,
wherein, in a case where the location extracted by the extraction unit is edited two times by the user, the specifying unit specifies first information specified in second editing to have usability higher than usability of first information specified in first editing.

9. The information processing apparatus according to claim 4,
wherein, in a case where the location extracted by the extraction unit is edited two times by the user, the specifying unit specifies first information specified in second editing to have usability higher than usability of first information specified in first editing.

10. The information processing apparatus according to claim 5,
wherein, in a case where the location extracted by the extraction unit is edited two times by the user, the specifying unit specifies first information specified in second editing to have usability higher than usability of first information specified in first editing.

11. The information processing apparatus according to claim 6,
wherein a value indicating the usability of the first information is obtained based on features obtained from the content information, and
the specifying unit outputs a value indicating the usability of the first information having details which have been re-described at the location, so as to be greater than a value indicating the usability of the first information which has been firstly specified, and outputs the value indicating the usability of the first information which has been firstly specified so as to be smaller than a value indicating the usability of the first information which has not been specified among the pieces of first information viewed by the user.

12. The information processing apparatus according to claim 7,
wherein a value indicating the usability of the first information is obtained based on features obtained from the content information, and
the specifying unit outputs a value indicating the usability of the first information having details which have been re-described at the location, so as to be greater than a value indicating the usability of the first information which has been firstly specified, and outputs the value indicating the usability of the first information which has been firstly specified so as to be smaller than a value indicating the usability of the first information which has not been specified among the pieces of first information viewed by the user.

13. The information processing apparatus according to claim 8,
wherein a value indicating the usability of the first information is obtained based on features obtained from the content information, and
the specifying unit outputs a value indicating the usability of the first information having details which have been re-described at the location, so as to be greater than a value indicating the usability of the first information which has been firstly specified, and outputs the value indicating the usability of the first information which has been firstly specified so as to be smaller than a value indicating the usability of the first information which has not been specified among the pieces of first information viewed by the user.

14. The information processing apparatus according to claim 9,
wherein a value indicating the usability of the first information is obtained based on features obtained from the content information, and
the specifying unit outputs a value indicating the usability of the first information having details which have been re-described at the location, so as to be greater than a value indicating the usability of the first information which has been firstly specified, and outputs the value indicating the usability of the first information which has been firstly specified so as to be smaller than a value indicating the usability of the first information which has not been specified among the pieces of first information viewed by the user.

15. The information processing apparatus according to claim 10,
wherein a value indicating the usability of the first information is obtained based on features obtained from the content information, and
the specifying unit outputs a value indicating the usability of the first information having details which have been re-described at the location, so as to be greater than a value indicating the usability of the first information which has been firstly specified, and outputs the value indicating the usability of the first information which has been firstly specified so as to be smaller than a value indicating the usability of the first information which has not been specified among the pieces of first information viewed by the user.

16. The information processing apparatus according to claim 1,
wherein the acquisition unit further acquires work information regarding a work which has been performed on the second information at at least one of a timing before the user views the first information, a timing in the user viewing the first information, or a timing after the user views the first information, and
the specifying unit further specifies the specified first information as first information having usability, by further using the work information.

17. The information processing apparatus according to claim 1,
wherein the acquisition unit further acquires interaction information being information regarding an operation performed on the first information by the user and work information regarding a work performed on the second information at at least one of a timing before the user views the first information, a timing in the user viewing the first information, or a timing after the user views the first information, and
the specifying unit obtains a value indicating usability of the specified first information based on features obtained from at least one of the content information, the interaction information, or the work information and further specifies the first information having the usability based on the obtained value indicating the usability.

18. The information processing apparatus according to claim 17,
wherein, in a case where it is determined that an evaluation of the usability of the first information is to be acquired from the user, the acquisition unit further acquires the evaluation of the first information for the usability from the user, based on the value indicating the usability.

19. The information processing apparatus according to claim 18,
wherein the first information having the usability is specified with a machine learning model in which the features are input, and the value indicating the usability is output, and
the information processing apparatus further comprises:
an update unit that updates the machine learning model by inputting a pair of the evaluation acquired by the acquisition unit and the features corresponding to the evaluation to the machine learning model, as learning data.

20. A non-transitory computer readable medium storing a program causing a computer to function as the units of the information processing apparatus according to claim 1.
